(19) United States
(12) Patent Application Publication
(10) Pub. No.: US 2010/0312385 A1
(43) Pub. Date: Dec. 9, 2010

(54) ELECTRONIC ORDERING SYSTEM FOR RESTAURANTS

(76) Inventor: Roger Deuber, Thalwil (CH)

Correspondence Address: DAVID A. GUERRA;INTERNATIONAL PATENT GROUP, LLC, Suite 700, 1816 Crowchild Trail N.W., CALGARY, AB, T2M 3Y7, CA

(21) Appl. No.: 12/678,530

(22) PCT Filed: Aug. 27, 2008
(86) PCT No.: PCT/CH08/00358

§ 371 Date: May 26, 2010

(30) Foreign Application Priority Data
Sep. 18, 2007 (CH) 1449/07
Nov. 1, 2007 (CH) 1695/07
Aug. 27, 2008 (CH) PCT/CH2008/000358

(51) Int. Cl. G06Q 50/00; H04Q 5/22; G08B 21/00; G06F 19/00; G06Q 30/00; G01G 19/00; G06K 5/00

(52) U.S. Cl. 700/245; 340/10.4; 340/666; 705/15; 705/14.64; 177/25.12; 235/380; 177/1

(57) ABSTRACT

An electronic ordering system for restaurants comprises an electronic menu (1) with a display device (3) for representing units that can be ordered, input means (4) for allowing a person placing an order to select a menu configuration, and a data transmitter (5) for transmitting data representing the menu configuration. The electronic ordering system further comprises a service point (7) where the person placing the order would like to receive his or her ordered menu configuration and which is equipped with an RFID reading device (9), and a data processing device (2) for receiving the data representing the menu configuration. The electronic menu (1) has an RFID tag (6) for identifying the same. The ordering system is configured such that the identification of the RFID tag (6) of the electronic menu (1) is linked to the service point (7) once the person placing the order has configured the menu, and the linked data is transmitted to the data processing device (2). The system allows a customer to be served in a highly individual manner, taking into account a nutritional profile the customer has predefined while rendering the ordering process, preparation of meals, and service efficient and keeping waiting times short. Mistakes when taking an order, garnishing plates and filling glasses or cups, and then bringing the ordered items to the customer's table are prevented. And foremost, the system according to the invention can be integrated in a largely inconspicuous manner into a conventional restaurant ambiance, thus maintaining a relaxed atmosphere for customers.

The invention relates to an electronic ordering system for restaurants, comprising an electronic menu with a display device to display available units, and input means to select a menu configuration by a customer and a data transmission device to transmit data representing the menu configuration, a serving place, such as a dining place at a table where the customer wishes to receive the menu configuration he or she has ordered, which is equipped with a RFID reader and a data processing device to receive the data representing the menu configuration.

Such an ordering system is known from U.S. 2006/0085266 A1. The well-known ordering system allows a guest in a restaurant to immediately place an order after a menu choice, without having to wait for the service staff. For this, the guest receives first of all a RFID tag, i.e. a radio frequency identification transponder, and thus is identified in a RFID system. In order to enter the menu choice into an electronic input device the guest places his or her RFID tag at the input device. Hereby, a personalized selection of food and drinks can be displayed, that for instance takes the calorie content or personal preferences into account, depending on additional information that the guest has entered.

The requested menu is transmitted to the kitchen, in conjunction with the identification of the guest by the RFID tag, via a wireless LAN and prepared according to the order. In the kitchen, the prepared food and drinks are put on crockery items, which in turn are marked with RFID tags. For this, a display device is placed in the kitchen, which directs the dishing up of the crockery items. After the dishing up, the crockery RFID tags are read in the kitchen using an RFID reader and are transferred to a data processing device. Thus, an ordered menu component is associated with an identifiable crockery item. After delivery to the guest, the RFID tag of the crockery item is read using an RFID reader at the serving place, i.e. at the dining place of the guest. If the RFID tag of the crockery item does not correlate with the order, an error message is generated.

The issue and handling of an RFID tag and its placement in an input device by a guest, however is error prone and furthermore conveys the impression of an electronic surveillance that is undesirable during a relaxed meal.

From DE 100 24 279 A1 it is known to implement the input device as an electronic menu with a touch panel, which, for example, is integrated into a table surface, a stand or also a, possibly, multi-page book. The requests that have been entered on the touch panel are transmitted to a central data processing device. On the electronic menu dynamically changing offers can be displayed. Moreover, it can be used for other communication purposes.

Furthermore, from U.S. 2003/0036977 A1 handheld electronic ordering modules are known, with which the service staff can take orders assigned to specific serving places and can transmit them wirelessly to the kitchen. Moreover the ordering data can be used to streamline the storage management of a restaurant and to arrange for timely reordering.

From JP 2005018181 A it is furthermore known to select suitable menus for a customer, that for instance take into account nutrition based allergies, based on personal information on his or her constitution, a menu database and a database of ingredients.

Starting from this point, the underlying task of the invention is to create an electronic ordering system for restaurants which causes the guest the least amount of intrusion, while it can all the same render custom tailored ordering suggestions that take into account individual criteria given by the guest.

This task is resolved by the invention of an electronic ordering system according to patent claim 1. Further advantageous embodiments of the invention are indicated in the claims.

According to the invention the electronic menu is designed to feature a RFID tag to identify itself. At the same time, the ordering system is configured in such a way, that once the customer has completed the configuration of the menu, the identification of the RFID tag of the menu is linked to the serving place and the associated data are transmitted to the data processing device.

The handling of the electronic menu differs here from that of a traditional menu card only by its feature that it allows the guest to straight away place his or her order once the choice is made. In particular, it is not necessary for the guest to first of all obtain a RFID tag and then to insert it into an input device before placing an order.

Of course, the guest can draw on the service staff for assistance in choosing the menu and placing an order. To call service staff, a suitable calling device can be provided at the serving place or be integrated into an electronic menu.

According to an advantageous embodiment, once the menu configuration has been completed, an order is triggered as soon as the RFID tag of the electronic menu is brought within a limited reception range of the RFID reader of a serving place. This can be done by the guest for instance by putting aside the electronic menu at the serving place, as is common practice with a traditional menu card, to indicate to well trained service staff that one has made ones choice. With the invented system however, the order has then already been transmitted to the kitchen, so that the service staff needs only to clear away the electronic menu.

The electronic menu is preferably designed as an electronic book, which the guest can browse through. For example, the menu can be bound in leather to convey a distinguished and dignified impression. When the guest flips open the menu card he or she finds an embedded flat bed screen. In a further advantageous embodiment, a touch screen or a touch panel is provided as input means to allow for interaction.

In order to ensure the transmission of the necessary data to the data processing device after the completion of the menu configuration, a prompt to put aside the electronic menu at the desired service place can be displayed on the display device. In addition, a message can be displayed, which reports a successful placement of an order to the guest.

In an advantageous embodiment of the invention, personal criteria of the guest can be entered interactively by means of the electronic menu, as already indicated. Subject to the criteria entered individualized ordering choices can then be displayed on the display device.

In order to enable an efficient processing of the order, an electronic system can be installed in the kitchen which supports the kitchen personnel in configuring the ordered menus.

To achieve this, preferably a dish-up counter is provided, which features identifiable parking positions for crockery items that need to be dished up compliant with orders. Display devices, connected to the data processing device, are assigned to the parking positions to display dish-up information for each of the crockery items to a dish-up supervisor. Thereby it is, for instance, easily possible to process the orders of a table jointly and to get them ready at the same time. The dish-up information comprises the desired products, and, if applicable, details regarding their preparation or cooking state and/or their amount, the arrangement of the individual components on or in a piece of crockery or special requests relating to nutrition habits or sensitivities.

The dished up crockery items are then brought to the respective serving place by the service staff.

According to a further advantageous embodiment of the invention, the crockery items are identifiable by RFID tags to exclude mix-ups. Beyond that, RFID reading devices can be set up at the parking positions. Also, it is possible to assign in the data processing device an identification of an electronic menu that is linked to an ordered menu configuration, to a single or several parking positions. In conjunction with the display devices that are assigned to the parking positions it is therefore known which components of an order are positioned on which crockery item, and this, because the dishing up of an identifiable crockery item takes place on instructions of the data processing device that are conveyed to a dish-up supervisor via the display device.

Further, weighing equipment can be provided at the parking positions, which records the weight of crockery items including their dished up menu components and transmits it to the data processing device. In the data processing device the dish-up configuration is continuously verified based on the weight information, so that mistakes can be signalled and corrected on time. Further, based on the weight information it is possible to control the dished up quantities and, where appropriate, to take into account special requests of the guest.

According to a further advantageous embodiment, the electronic ordering system comprises a distribution display device that communicates with the data processing device, which displays the parking position of the crockery item in relation to its serving place, once it has been dished up. Thus the service staff can recognize on the one hand which crockery items are ready for delivery, and on the other hand, where they are to be delivered to. The risk that the service staff forgets whereto individual crockery items need to be delivered is thus reduced to a minimum. Mix-ups due to information overload of the service staff are thus virtually ruled out.

Nevertheless, it is however possible to monitor the delivery of dished up crockery items in the background, so that if the service staff should make a mistake it is possible to react quickly. For this purpose, it is intended that the RFID reader at the serving place reads the RFID tag of a crockery item parked at the serving place and transmits it to the data processing device. In the data processing device it is straight away verified, if the crockery RFID tag registered at the serving place coincides with crockery RFID tag registered at the parking position. When a deviation occurs an error message can be generated.

The invented electronic ordering system can also be used to make other purchases during the time between the relay of the order and the serving of the menu. To this end, according to a further advantageous embodiment of the invention, access to one or several databases can be provided, that list available products, which can be ordered by activating the input means of the electronic menu. Contrary to the usual practice, the guest gets to keep the electronic menu as long as he or she wants and need not give it back straight away after placing a menu order.

Basically, by means of the electronic menu it is possible, for instance by accessing the internet, to place orders at any place or to communicate with internet contents. In a preferred system configuration the guest is allowed access only to such databases, which are assigned to locations of providers which are in an area within limited distance from the serving place, such as 1000 m. Thus the shopping possibilities can be limited to stores in the vicinity or to the company operating the restaurant. This feature has several advantages. On the one hand the guest is shielded from information overload and is only offered products, that he or she can pick up straight away after visiting the restaurant or respectively, that can be delivered to the guest during a customary length of stay at the restaurant.

On the other hand, this enables the operator of the restaurant to grant concessions to external service providers.

In a first variant of the embodiment, the databases are held accessible in a local data processing device. In a second variant of the embodiment external databases are accessed via the local data processing device.

In order to identify a customer, it can be provided that he or she needs to enter respective data by means of the electronic menu card. For regular guests such data can also be held on a password protected user account. In order to facilitate the carrying out of the ordering process, since a complete data entry generally is rather complicated, the ordering data can be linked to the serving place and to the identification of the RFID tag of the menu when dispatching an order. The receiver of the order therefore knows to which serving place an order needs to be assigned to and can mark it correspondingly or deliver it directly to the serving place.

According to a further advantageous embodiment of the invention, pick-up compartments to receive ordered products are set up in the vicinity of the serving place to avoid any disturbance of the guest while he or she is enjoying the meal.

In principle it is possible to carry out the hand over of the ordered products by staff, for instance of the restaurant in which the meal is had. In this case, the ordered products can be paid for together with the meal at the handover.

But it is also possible to provide for a pickup by the guest. According to a further advantageous embodiment of the invention, in the data processing device the linked ordering data are allocated a pick-up compartment and this is brought to the customer's attention on the display device of the electronic menu to ensure that the guest finds the ordered products. The pick-up compartment and the linked ordering data are transmitted to the provider, so that he knows whereto to deliver.

In a preferred embodiment, the pick-up compartment can be closed and the closure can only be opened by the customer placing an order to withdraw the deposited products. This ensures that the customer actually receives the requested products he or she has possibly already paid for.

In case of a pickup by the customer, it can be provided that the opening of the closure requires the input of an identification code, which is passed on to the customer by the data processing device.

Furthermore, the opening of the closure requires a prior payment of the of the ordered products. To avoid frolic orders it makes sense to link the payment immediately to the ordering, so that the provider does not run the risk of carrying out a delivery to a pick-up compartment, which is not accepted.

The location of a provider can be a warehouse, where a device to receive and output electronically transmitted ordering data is set up. The ordered products are then collected together and delivered by service staff.

The collecting of the products can also be automated. Preferably, the location of a provider is a high bay warehouse operated by a robot. The control of the robot to collect the ordered products is done in this case automatically subject to the ordering data electronically generated by the customer placing an order.

The payment, both for the menu and the ordered products can be settled in the restaurant in conventional manner by cash. However, in addition the option of paying by electronic means can be provided.

For this a credit card reader can be set up in the vicinity of the serving place, which can be operated without approaching the service staff. By a credit card reader are understood devices of all sorts that can not only read credit cards in the sense proper, but also support all kinds of card-driven payment systems.

The credit card reader can be securely attached to the electronic menu or set up as a stationary unit at the serving place, in which case the credit card reader can also be accessed from neighbouring serving places. For example, it is possible to provide a credit card reader for each table.

Furthermore, it is possible to design the credit reader as a mobile unit, which is brought to the guest by the service staff.

Particularly when operated without service staff, it is advisable that the credit card reader has a function display.

Subsequently the invention is described in more detail based on embodiments shown in the drawing. The drawing in

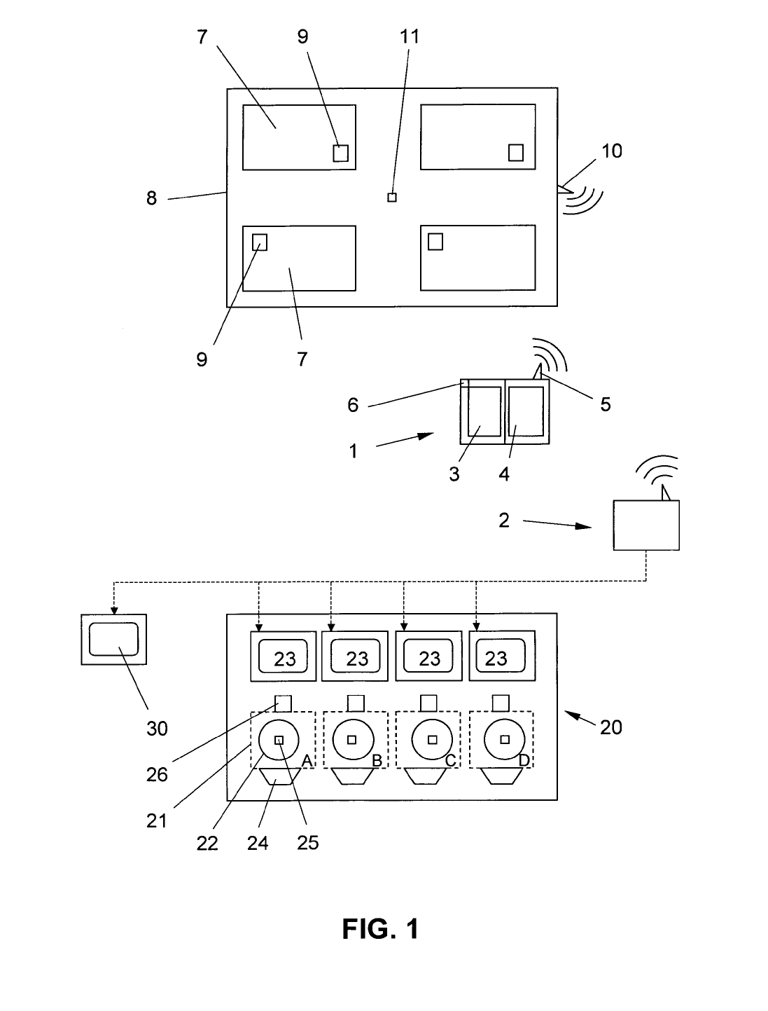

FIG. 1 shows a schematic representation of an electronic ordering system according to a first embodiment of the invention, and

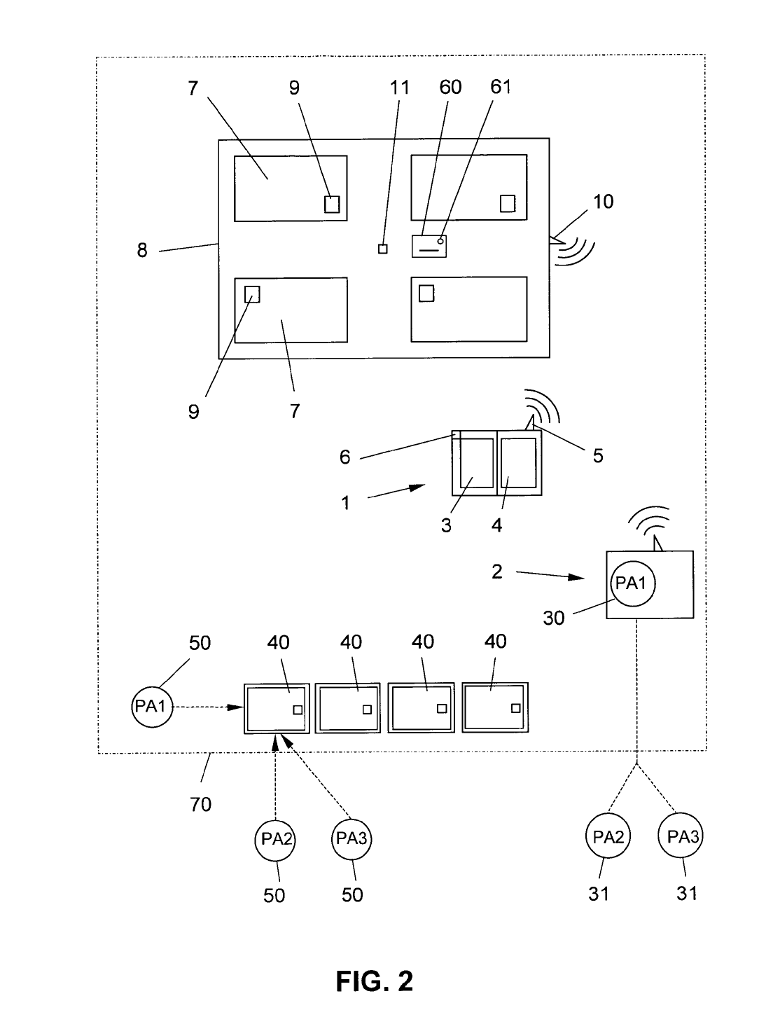

FIG. 2 shows a schematic representation of an electronic ordering system according to a second embodiment of the invention.

The first embodiment shows an electronic ordering system for restaurants, with which orders can be placed using an electronic menu 1. By means of the electronic menu 1 personalized ordering choices can be submitted to a guest based on a profile previously queried. Thereby one can take into account, for example, intolerances to certain foods, dislikes of certain foods, allergies, calorie allowances, budget requirements, medical diets, religious criteria, biological products, preparation requests and other special needs. A corresponding profile can for example be stored and password protected in a central data processing device 2 in connection with user identification, so that it is available again on frequent visits and needs not to be entered anew. In addition, the access can be designed in such a way that it allows access to the data from different restaurants. The respective data can be entered by means of the electronic menu 1 which is connected to the data processing device 2 via a WLAN or via other basically well known means of data transfer

The electronic menu 1 has a display device 3, for example a screen for displaying available units. Furthermore, the electronic menu 1 features input means 4 allowing a customer to select a menu configuration. In the illustrated embodiment the electronic menu 1 features also a data transmission device 5 to transmit data representing the menu configuration to the data processing device 2. Moreover, the electronic menu 1 has an integrated RFID Tag 6, which allows to identify the electronic menu 1.

Externally, the electronic menu 1 of the embodiment looks like a conventional menu card in book form, so that for the guest the ambience of the restaurant is not compromised by directly perceptible electronic frippery. The electronic menu 1 can for example be bound in leather, making it look very distinguished and dignified.

When the guest flips open the menu card 1 he or she finds an embedded flat bed screen with a touch screen, which acts as input means 4. He or she can then browse through the electronic menu 1 and interact by means of the touch screen with a computer program, which is installed either directly in the electronic menu 1 or else in the data processing device 2. By interacting with the computer program menu suggestions can be studied and orders can be placed. It is also possible to obtain a password protected user identification and thus to enter personal data in view of the above criteria, whereupon personalised menu suggestions are provided by the computer program. In addition, menu preferences can be earmarked and a menu history can be stored in the user area, so that it is possible to revert to this data on occasion of a renewed visit. Of course, the guest can change the criteria once given.

The program guidance can be chosen freely to a large extent. For instance, two different windows can be displayed on the screen for the guest, namely one, in which to enter personal data, and another, in which to choose, respectively configure the menu. Once the customer has completed the configuration of the menu, the associated data are transmitted to the data processing device 2 by means of the data transmission device 5 of the electronic menu 1. The data of the menu configuration are thereby linked to the identification of the RFID tag 6 of the electronic menu 1.

The ordering system further comprises a serving place 7, at which the customer wishes to receive the menu configuration he or she has ordered. The serving place 7 is for example a dining place at a table 8, but may be any place that is booked in the ordering system as the place of reception and delivery of orders. Each serving place 7 is equipped unobtrusively with a RFID reader 9, which is connected to the data processing device 2. Again, a wireless connection can be provided, whereby it is advantageous to switch all the RFID readers 9 of a table 8 to a common data transmission device 10 when exchanging data with the data processing device 2. The position of the RFID readers 9 is stored in the data processing device 2, so that a RFID tag which has been recorded via a RFID reader 9 can be localised in the data processing device 2.

Once the customer has completed to configure the menu, in addition to the respective data, a data set is created which links the identification of the RFID tag 6 of the electronic menu 1 to the serving place 7. These linked data are also transmitted to the data processing device 2. By the identification of the RFID tag 6 of the menu 1, the menu configuration and the information on the serving place 7 are joined in the data processing device 2.

However, an order is triggered only when, once the menu configuration has been completed, the RFID tag 6 of the menu 1 is brought within a limited reception range of the RFID reader 9 of a serving place 7. This is to ensure that a menu configuration and a serving place 7 are correctly linked. Preferably, this occurs by putting aside the electronic menu 1 at the serving place 7. Correspondingly, the sensitivity of the reader 9 is attuned to the transponder of the RFID tag 6 of the menu 1 in a way that an order is triggered only within a close range, say of up to 10 cm, of the reader 9

To ensure that, once the menu configuration has been completed an order is triggered, a prompt to deposit the electronic menu 1 at the desired serving place 7 appears on its display device 3. In addition a message can be displayed on the electronic menu 1, which reports a successful placement of an order to the customer.

Above it has always been assumed that the electronic menu 1 is operated by a guest as the ordering customer. Of course, the input of an order can also be carried out by the service staff, who can be called by means of a calling device 11 integrated in a table 8 or the electronic menu 1. In addition, electronic menus 1 with expanded functionality and access permissions can be provided specifically for the service staff, to enable them to transmit, for instance, additional information to the kitchen, of which the customer need not be aware of.

The menu configurations recorded at table 8 are processed in the data processing device 2 and are translated into instructions for the kitchen. Thereby, different preparation times can be automatically attuned to each other in such a way, that all serving places 7 of a table 8 are served at the same time.

To this end, there is a dish-up counter 20 in the kitchen with identifiable parking positions 21 for crockery items 22, such as plates or drinking-vessels that need to be dished up compliant with orders. In FIG. 1 different parking positions 21 are marked with the letters A, B, C and D. A display device 23, which is connected to the data processing device 2, is assigned to each parking position 21. The display devices 23 are preferably screens or sections of screens. Dish-up information that has been generated in the data processing device 2 is issued by means of the display devices 23 to a dish-up supervisor as instructions, which he or she then only needs to carry out. The instructions are structured in a manner, that single successive steps are indicated to the dish-up supervisor, to avoid him or her loosing track.

Additionally, weighing equipment 24 can be provided at the parking positions 21, which records the weight of crockery items 22 including their dished up menu components and transmits it to the data processing device 2. In the data processing device 2 the dish-up configuration is continuously verified based on the weight information. For example, a weight increase can be interpreted to the effect, that the previously issued instruction has been carried out, and to then proceed to the next instruction. Moreover, the extent of the weight increase can be used to evaluate the carrying out of an instruction. If there is a deviation from the expected result, this is rated as an error and brought to the attention of the dish-up supervisor, so that he or she can check and, if appropriate, correct the action.

The weight information may also be used to take into account special requests of a customer relating to the size of the portion For this purpose, information on the targeted and actual weight can be displayed on the display device 23 to the dish-up supervisor, so that he or she can dish up a specified amount precisely.

The instructions for each parking position 21 are generated on the basis of the ordered menu configuration which is linked to the identification of an electronic menu 1. Thereby it is ultimately known, at which parking position 21 a menu for a specific serving place 7 is just being dished up.

Furthermore, the electronic ordering system comprises a distribution display device 30, that communicates with the data processing device 2, for instance in form of a screen on which the parking position 21 of the crockery item 22 is displayed in relation to its serving place 7, once it has been dished up. Thus, the service staff can pick up the dished up crockery item 22 at the parking position 21 and bring it to the appropriate serving place 7.

In the illustrated embodiment, the crockery items 22 are additionally identifiable by crockery RFID tags 25, which are stuck onto or integrated into these.

Furthermore, RFID reading devices 26 are located at the parking positions 21, which are connected to the data processing device 2, to transmit the identification of a crockery item 22 that is just located at a parking position 21, to the data processing device 2. The identification of the crockery item 22 is then assigned to the data set of the ordered menu configuration or parts of thereof, as for instance, the serving place 7. This makes it possible to control the correct delivery of the crockery item 22 and to thereby ensure, that the guest receives the requested order.

To this end, the RFID reader 9 at the serving place 7 reads the crockery RFID tag 25 of each crockery item 22 parked at the serving place 7 and transmits its identification to the data processing device 2. In the data processing device 2 it is straight away verified, if the crockery RFID tag 25 registered at the serving place 7 coincides with crockery RFID tag 25 registered at the parking position 21. When a deviation occurs, an error message is generated and signalled to the service staff. By using suitable transponders on the crockery items 22 in conjunction with receivers carried along by the service staff, it is possible to signal the service staff discreetly the error already when a crockery item 22 is approaching a wrong service place 7.

By the electronic ordering system described above an individualised hospitable catering for a guest, taking into account his or her given nutrition profile, is ensured, which exceeds the capabilities of even the best trained service staff by far. In addition the system enables an efficient ordering, food preparation and service with short waits. It reliably avoids errors when taking orders, dishing up the crockery items 22 and the subsequent delivery to the guest. Above all, the system according to the invention can be integrated in a traditional restaurant ambiance to the largest extent discreetly, so that a relaxed atmosphere is preserved for the guest.

FIG. 2 shows a second embodiment of an electronic ordering system for restaurants. The second embodiment includes all the components of the first embodiment, so that related to those it is referred to the explanations above. However, to simplify the representation, the dish-up counter 20 and the distribution display device 30 are not shown in FIG. 2, since, optionally, these can be left out.

The electronic ordering system of the second embodiment provides the guest additionally the opportunity to make good use of the waiting period, from placing an order to receiving the menu, for further activities, namely to do or at least initiate his or her shopping in nearby stores or in the store of the restaurant operator. Thus, for example, the appropriate groceries for dinner, which the guest would like to prepare at home, can be bought.

Respective offers are held in one or several databases, which contain datasets of available choices of products. In the illustrated embodiment, such a database 30 is stored directly in the local data processing device 2 of the ordering system. This database 30 represents the choice of products PA1 of the restaurant operator. Furthermore, the local data processing device 2 is electronically connected to external databases 31, which display the choice of products PA2 and PA3 of nearby locations of providers 50, respectively stores, at which the guest can drop by rapidly after the visit of the restaurant, respectively from which the ordered products can be delivered directly to the guest within the period of his or her stay at the restaurant or to some other designated place. Periods of up to one hour are regarded as a standard duration of a stay.

Where appropriate, a feature may be provided with which the guest can enter the intended length of stay by means of the electronic menu 1, whereupon he or she is only presented a choice of products that can be delivered within this time limit.

Of course, the guest can also pick up the ordered products after the visit of the restaurant directly at the location of the provider 50.

The inclusion of third-party choices of products opens up new sources of revenue for the operator of the restaurant, since he can, for instance, issue concessions for hosting their choices of products or charge a provision for completed purchases.

External ordering options are ideal in shopping centres and the like, where the restaurant 70 and the external locations of providers 50 are located close to each other in the same building complex.

The choice of products is submitted to the guest via the display device 3 of the electronic menu 1 Orders can be placed using the input means 4 of the electronic menu 1. In the illustrated embodiment, the ordering data are linked to the serving place 7 and the identification of the RFID tag 6 of the electronic menu 1, so that the ordered products can be assigned to the customer. Alternatively or additionally it can be provided, that the guest, respectively the customer, enters identification data with the input means 4. The latter is advantageous especially when the guest intends to pick up the ordered goods at the location of a provider 50 personally.

As FIG. 1 also shows, pick-up compartments 40 are set up in the vicinity of the serving place 7 to receive the ordered products. The ordered products can be taken along by the guest at the end of his stay at the restaurant. The pick-up compartments 40 are located either directly in the restaurant 70 or at a nearby centralised location.

In order to facilitate the delivery to the pick-up compartments 40, the linked ordering data are assigned to a pick-up compartment 40 in the data processing device 2, which is brought to the customer's attention on the display device 3 of the electronic menu 1. The guest knows therefore where to find the ordered products. In addition this information is transmitted together with the linked ordering data to the provider at the place of the provider 50, so that the ordered products can be delivered to the correct pick-up compartment 40, without disturbing the guest during his meal.

The pick-up compartments 40 can be closed, so that unauthorised persons cannot get at their content. Nevertheless, the possibility is provided for the suppliers to deliver the ordered products to the pick-up compartments 40. The closure can only be opened by the customer placing an order so as to withdraw the deposited products. This can be carried out for instance so, that once the customer has placed an order the data processing device 2 passes on an identification code to him or her, which must be entered to open the closure.

In addition, it can be provided that opening the closure requires a prior payment of the ordered products. Preferably, the ordering process is linked directly with the payment process so that ordered products are only delivered, when these have also been played for.

The delivery can be carried out for instance from a store in the vicinity of the restaurant. Furthermore, the location of a provider 50 can be a mere warehouse, which is not accessible to the public. In the warehouse there is a device to receive and output electronically transmitted ordering data. Based on the outputted data the ordered products are manually carried together and brought to the serving place 7 or to the pick-up compartment 40. It is also possible to conceive such a warehouse as a high rack warehouse operated by a robot. The control of the robot to collect the ordered products is done subject to the ordering data electronically generated by the customer placing an order, whereby control instructions for the robot are generated automatically based on the ordering data.

The embodiment further shows a credit card reader 60 in the vicinity of the serving place 7, whereby an electronic payment is enabled, that does not require the service staff to attend. The credit card reader 60 features a function display, based on which the customer can recognise if a payment is possible. This can for example be achieved by the feature, that after inserting the credit card an indicator lamp 61 or a screen are turned on.

The number of credit card readers 60 depends on economic circumstances. For example, a credit-card reader 60 can be integrated in each electronic menu 1. In the illustrated embodiment, a credit card reader 60 is set up as a stationary unit at a serving place 7, whereby in this instance at table 8 one credit card reader 60 is provided, which is accessible by several serving places 7. However, it is also possible to assign an individual credit card reader 60 to each serving place 7 The credit card reader 60 can also be designed as a mobile unit, which is brought to the table by the service staff to receive payment.

A credit card reader 60 can also be set up, independent of the function allowing to make further purchases, to settle the bill after completing the meal without having to wait for the service staff. In any case, the paying process can thus be speeded up.

1-31. (canceled)

32. An electronic ordering system for restaurants, comprising:
an electronic menu with a display device to display available items, input means allowing a customer to select a menu configuration, a data transmission device to transmit data representing said menu configuration, and an RFID-tag to identify said electronic menu;
a serving place where said customer wishes to receive said menu configuration said customer has ordered, said serving place being equipped with an RFID reader, and a data transmission device connected to said RFID reader; and
a data processing device to receive said data representing said menu configuration;
wherein said electronic ordering system is devised that once said customer has completed said menu configuration the following actions take place;
wherein said RFID-reader of said serving place reads an identification of said RFID tag of said electronic menu and links said identification to said serving place, and said linked data are transmitted to said data processing device using said data transmission device that is connected to said RFID reader of said serving place;
wherein said data of said menu configuration are linked to said identification of said RFID-tag of said electronic menu and said linked data are transmitted to said data processing device by means of said data transmission device of said electronic menu;
wherein said data of said menu configuration and information on said service place are joined by means of said identification of said RFID-tag of said electronic menu.

33. The electronic ordering system according to claim 32, wherein said electronic menu is an electronic book.

34. The electronic ordering system according to claim 32, wherein said input means of said electronic menu is a touch screen or a touch panel.

35. The electronic ordering system according to claim 32 further comprising crockery items having a crockery RFID tag, said crockery RFID tag identifies said crockery items.

36. The electronic ordering system according to claim 35 further comprising a dish up counter having identifiable parking positions for said crockery items that need to be dished up with menu components compliant with orders, and at least one display device assigned to each of said parking positions, said display device being connected to said data processing device to display dish up information for each of said crockery items to a dish up supervisor.

37. The electronic ordering system according to claim 35 further comprising at least one weighing equipment provided at each of said parking positions that records a weight of each of said crockery items, including their dished up menu components and transfers it to said data processing device.

38. The electronic ordering system according to claim 35 further comprising a distribution display device communicating with said data processing device, said distribution display device displays said parking position in relation to said serving place of said crockery items that have been dished up with menu components.

39. The electronic ordering system according to claim 35 further comprising at least one database accessible by at least said electronic menu, said database containing available products, which are orderable by said customer using said input means of said electronic menu.

40. The electronic ordering system according to claim 39, wherein said database is held accessible in said data processing device, or wherein said data processing device is connected to external databases.

41. The electronic ordering system according to claim 39, wherein said databases are assigned to places of providers which are located in an area within a determined distance from said serving place, wherein the location of a provider is a warehouse where a device to receive and output electronically transmitted ordering data is provided, wherein a location of said provider is a high rack warehouse operated by a robot, wherein control of said robot to collect ordered products is done subject to ordering data electronically generated by said customer placing an order.

42. The electronic ordering system according to claim 35 further comprising pick-up compartments to receive ordered products, said pick-up compartments being located in the vicinity of said serving place.

43. The electronic ordering system according to claim 35 further comprising a credit card reader located in the vicinity of said serving place, said credit card reader having a function display.

44. The electronic ordering system according to claim 43, wherein said credit card reader is selected from the group consisting of as being securely attached to said electronic menu, as being a stationary unit at said serving place, and as being a mobile unit.

45. A method of electronically ordering a product once a customer has completed a menu configuration using an electronic ordering system, said method comprising the steps of:
a) providing an electronic ordering system comprising at least an electronic menu, a serving place, and a data processing device, said electronic menu having at least a display device, input means, a data transmission device, and an RFID-tag, said serving place having at least an RFID reader, and a data transmission device connected to said RFID-reader;
b) reading identification data of said RFID tag of said electronic menu by said RFID-reader of said serving place;
c) linking said identification data to said serving place;
d) transmitting said linked identification data from step c) to said data processing device using said data transmission device connected to said RFID reader of said serving place;
e) linking data of a menu configuration to said identification data of said RFID-tag of said electronic menu;
f) transmitting said linked menu configuration data from step e) to said data processing device using said data transmission device of said electronic menu; and
g) joining said data of said menu configuration and information on said service place by means of said identification data of said RFID-tag of said electronic menu.

46. The method according to claim 44 further comprising the steps of:
h) triggering an order once said menu configuration is completed and said RFID-tag of said electronic menu is brought within a limited reception range of said RFID reader of said serving place;
j) prompting on said display device of said electronic menu, once said menu configuration has been completed, a prompt to deposit said electronic menu at said desired serving place; and
k) displaying a message to a customer on said display device of said electronic menu that said order was successfully triggered.

47. The method according to claim 46 further comprising the step of l) entering interactively personal criteria of said customer by means of said electronic menu, and displaying to said customer by said display device of said electronic menu individualized ordering choices, said individualized ordering choices are subject to said personal criteria entered.

48. The method according to claim 47 further comprising the step of m) providing a dish up counter having identifiable parking positions for crockery items that need to be dished up with menu components compliant with said order, said dish up counter further comprising display devices assigned to said parking positions which are connected to said data processing device to display dish up information for each of said crockery items to a dish up supervisor.

49. The method according to claim 48 further comprising the step of n) assigning one or more parking positions to said identification data of said electronic menu by said data processing device.

50. The method according to claim 49 further comprising the steps of:
o) recording a weight of said crockery items including said crockery items dished up menu components on said parking positions using a weighing equipment provided at each of said parking positions, and transmitting said recorded weight to said data processing device;
p) verifying continuously by said data processing device the dished up menu configuration based on said weight information, and generating an error message and alerting said dish up supervisor if a deviation is determined;
q) displaying said parking position in relation to said serving place of said crockery items that have been dished up with menu components using a distribution display device that is in communication with said data processing device.

51. The method according to claim 50 further comprising the steps of:
r) reading information from an RFID-tag of said crockery items parked at said serving place by said RFID reader of said serving place, and transmitting said information to said data processing device;
s) examining said information from step r) using said data processing device, and determining if said information from step r) if said RFID tag of said crockery item registered by said RFID readers at said serving place coincides with said RFID tag of said crockery item registered by said RFID readers at said parking positions, and given a discrepancy, generating an error message;
t) linking said ordering data to said serving place and to the identification of said RFID tag of said electronic menu;
u) assigning in said data processing device said linked ordering data from step t) to a pick-up compartment, notifying said customer of said assignment on said display device of said electronic menu, and transmitting to a place of a provider identification data of said assigned pick-up compartment together with said linked ordering data; and
v) opening said pick-up compartment is restricted to said customer placing said order so as to withdraw deposited products, or requires input of an identification code which is passed on to said customer by said data processing device, and/or requires a prior payment of said ordered products.
